(19) United States
(12) Patent Application Publication
(10) Pub. No.: US 2006/0212214 A1
(43) Pub. Date: Sep. 21, 2006

(54) System and method for guiding an individual in a predetermined zone

(75) Inventors: Fabrice Tran Xuan, Eybens (FR); Eric Villain, Saint Martin d'Heres (FR); Alain Prola, Grenoble (FR)

Correspondence Address: COHEN, PONTANI, LIEBERMAN & PAVANE, Suite 1210, 551 Fifth Avenue, New York, NY, 10176, US

(73) Assignee: France Telecom, Paris (FR)

(21) Appl. No.: 11/355,234

(22) Filed: Feb. 15, 2006

(30) Foreign Application Priority Data
Dec. 20, 2004 (FR) 0413556

(51) Int. Cl. G01C 21/00; G06F 17/00; G08B 13/14; G08B 23/00; G08G 1/123

(52) U.S. Cl. 701/201; 340/572.1; 340/995.19; 340/573.1; 235/375

(57) ABSTRACT

This system for guiding a person to a destination situated in a predetermined area comprises a fixed guidance station (10) comprising:
means (12) for reading a code associated with a destination;
wireless communication means (14) having a standby mode and a low electrical power consumption mode for:
   sending a request including said code associated with a destination and said indication of the position of said fixed station to a route determination device (20); and receiving a response including that route; and means for conveying said route to the person.

### BACKGROUND OF THE INVENTION

The present invention relates to a system and a method for guiding a person in a predetermined area.

A preferred and non-limiting use of the invention is to guide persons in one or more storeys of a building.

Satellite guidance techniques (GPS, etc.) cannot be used for this purpose because they cannot distinguish between the various storeys of a building and require the use of relatively costly terminals.

Also known in the art is a positioning and guidance method proposed by the company EKAHAU and described in the document published on the Internet at the address http://www.ekahau.com/products/positionengine/.

That positioning method is based primarily on measuring the power of the signals received from the person or object to be guided by stations conforming to the Wi-Fi standard (IEEE 802.11a/b/g) and comparing the measurements with calibration measurements effected beforehand, throughout the coverage area, typically when installing the stations.

When the area to be covered is large, to be efficient the above type of system requires the installation of a large number of radio beacons and therefore becomes costly.

Furthermore, that installation necessitates a tiresome preliminary calibration phase that in practice cannot be envisaged for the installation of a guidance system in a temporary area or an area whose topology varies (exhibition hall, museum, etc.).

### OBJECT AND SUMMARY OF THE INVENTION

The present invention therefore aims to alleviate the above drawbacks by proposing a guidance system and method that are simple to install, easy to reconfigure, method that are simple to install, easy to reconfigure, low in cost and able to guide a person in a building comprising several storeys.

To this end, in a first aspect, the invention provides a fixed station for guiding a person in a predetermined area, comprising a memory for storing an indication of the position of the fixed station, and:

means for reading a code associated with a destination to which a person situated in the vicinity of the station wishes to go;

wireless communication means for:
sending a request including the code associated with a destination and the indication of the position of the fixed station to a route determination device; and
receiving a response including a route between the station and the destination associated with the code; and

means for delivering the route to the person.

In the present document, the code associated with a destination may contain either the destination as such or any type of information enabling that destination to be obtained directly or indirectly.

The wireless communication means preferably have a standby mode and a low electrical power consumption operational mode.

According to the invention, the route produced is a route between the fixed guidance station and the destination associated with the code. Thus the invention does not relate to prior art guidance stations, typically found in train stations, which are adapted to deliver itineraries to destinations pre-stored in the guidance station, each of which destinations may be selected by means of a button, for example.

In a second aspect, the invention provides a device for determining a route for a person in a predetermined area, the device comprising:

means for determining a route between two positions in the predetermined area; and

wireless communication means adapted:
to receive a request including a code associated with a destination and a stored position indication sent by a fixed guidance station of the above kind; and
to send the fixed station a response including a route between the station and the destination associated with the code.

The wireless communication means are preferably low electrical power consumption means.

In a third aspect, the invention provides a system for guiding a person in a predetermined area, the system comprising a fixed guidance station and a route determination device as specified above.

The guidance system of the invention is particularly easy to install since it requires no calibration stage, given that the position of the person at the time of interrogating the guidance system corresponds to the position of the fixed station.

Accordingly, for an installation in a new building, it suffices to reposition the fixed stations and to modify their positions in the guidance system.

In practice it suffices to list the position of each of the fixed guidance stations at the time of their installation, which can be done very simply even in the case of a temporary installation.

For example, each station includes means for storing its position and the position indication sent to the route determination device corresponds to that position as such.

The position of each station is preferably stored in the route determination device in association with a unique identifier of the station, the position indication sent by the station then consisting of that unique identifier.

In an exhibition hall, the position of a station may consist of a storey, a hall number, an aisle number, and a row number, for example.

The guidance station and the route determination device of the invention include wireless communication means of low electrical power consumption.

In the context of the present document, communication means are considered to be of low electrical power consumption if they have an instantaneous power consumption in use of less than 45 milliwatts (mW). This excludes in particular the use of the Wi-Fi technology, the existing modules of which have power consumptions of not much less than 1 watt (W) in operation.

Moreover, if the wireless communication means of the guidance station are inactive, they are in a standby mode drawing virtually no electrical power, just a few microwatts (μW). This feature cannot be achieved with Wi-Fi modules either, which require a permanent radio link to avoid the period of around 10 seconds necessary to set up a link for each interrogation.

By means of the above features, the fixed guidance station may be used autonomously, that is to say on battery power, for about 10 days, which is particularly beneficial for use in a temporary installation.

The reading means of the guidance station preferably include a radio-frequency identification (RFID) module adapted to communicate with an electronic tag storing the code associated with a destination.

This preferred embodiment is very simple for the person to use, since the electronic label, which is incorporated into a badge, for example, merely has to be brought near the guidance station.

Alternatively, the user can enter the code associated with a destination using a bar code reader, a keypad, a touch-sensitive screen, or any other type of input means.

The route determination device of the invention preferably includes means for formatting the response as a function of the capacities of the delivering means and/or the person.

The formatting means may in particular trace the route onto a map of the predetermined area, to facilitate visualization of the route by the person.

Alternatively, the response may be a voice message, especially for the visually-handicapped.

A preferred embodiment of the determination device of the invention includes:

a mediation module incorporating the low power consumption communication means; and

a central system incorporating the determination means, the central system and the mediation module being connected to each other via a local area network.

The optional formatting means may in particular be incorporated into the mediation module or into the central system.

The progressive network is preferably a daisychain network.

This kind of topology is particularly simple to install, especially in a room, in which case the various transmission modules may be disposed progressively along the wall.

In this preferred embodiment the determination means on a distant network may therefore be centralized in the central system, which may be shared by different guidance systems, which may be independent of each other.

The guidance system of the invention preferably further includes a relay including low electrical power consumption wireless communication means adapted to transmit the request and the response mentioned above step by step between the guidance station and the route determination device.

The relays preferably constitute a daisychain network.

A guidance system can therefore be put together in which the route determination device can be out of range of a guidance station.

The relays may preferably consist of guidance stations of the invention.

Correspondingly, the invention provides a related method of guiding a person in a predetermined area, the method comprising:

a step of the determination device determining a route between its position and the destination associated with the code;

a step of the determination device sending to the station a response including the route; and

a step of delivering the route to the person.

In a preferred implementation of the method, the steps of the method are determined by computer program instructions.

Consequently, the invention also provides a computer program on an information medium, the program being adapted to be used in a guidance station of the invention and comprising instructions adapted to execute the following steps:

reading a code associated with a destination;

sending a route determination device a request including the code associated with a destination and a position indication stored by the station;

receiving from the determination device a response including a route between the station and the destination associated with the code; and

delivering the route to the person.

This program may use any programming language and take the form of source code, object code, or an intermediate code between source code and object code, for example a partially compiled form, or any other desirable form.

The invention also provides an information medium readable by an interaction module and containing instructions of a computer program as mentioned above.

The information medium may be any entity or device capable of storing the program, for example storage means such as a ROM, for example a CD-ROM or a micro-electronic circuit ROM, or magnetic recording means, for example a diskette (floppy disk) or a hard disk.

Furthermore, the information medium may be a transmissible medium, such as an electrical or optical signal, which may be routed via an electrical or optical cable, by radio or by other means. The program of the invention may in particular be downloaded over an Internet-type network.

Alternatively, the information medium may be an integrated circuit incorporating the program and adapted to execute or to be used in the execution of the method in question.

The particular advantages of the guidance method, the computer program and the information medium being exactly the same as those of the guidance station referred to above, they are not repeated here.

### BRIEF DESCRIPTION OF THE DRAWINGS

Other features and advantages of the present invention become more clearly apparent on reading the following description of two particular embodiments of the invention, the description being given by way of non-limiting example only and with reference to the appended drawings, in which:

FIG. 1 represents a first embodiment of a guidance system of the invention;

FIG. 2 represents a second embodiment of a guidance system of the invention; and

FIG. 3 is a flowchart representing the main steps of a preferred embodiment of a guidance method of the invention.

### DETAILED DESCRIPTION OF ONE EMBODIMENT

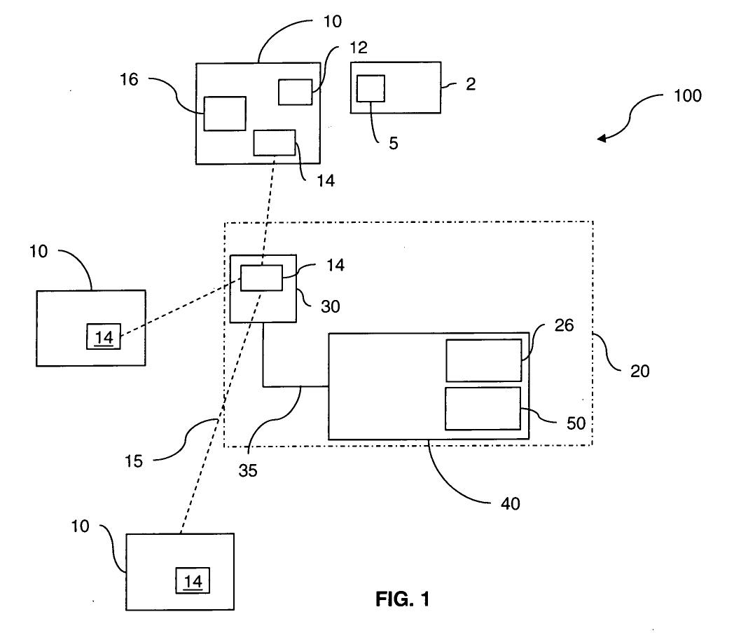

FIG. 1 represents a first embodiment of a guidance system 100 of the invention.

This guidance system may be used to guide a person in a predetermined area, consisting in the present example of a building, not shown in the figure.

It is assumed below that this person has a badge 2 incorporating an electronic tag 5 storing a code associated with a destination to which the person has to go.

The badge 2 may be a personnel badge or a badge handed out temporarily while moving around in the building.

The system 100 of the invention includes a fixed guidance station 10 adapted to deliver guidance information to guide the person to said destination.

In the embodiment described here, an indication of the position of the fixed station 10 has been configured beforehand by an administrator in a memory, not shown here, of the station 10.

The fixed station 10 includes means 12 for reading the code associated with a destination stored in the electronic label 5.

In the preferred embodiment described here, the reading means use the radio-frequency identification (RFID) protocol to communicate with the electronic tag 5.

The preferred embodiment described here uses the TagProduct LECT0025 tag reader. Additional information on this component may be obtained at the following address:

http://www.tagproduct.com/rfid/Materiels/doc/LFCT0025.pdf.

This component consumes:

0.1 amps (A) at 3 volts (V) when it is active; and

0.03 A at 3 V in standby mode.

The guidance station 10 also includes wireless communication means 14 with a route determination device 20.

In the embodiments described here, the determination device 20 is a route calculation device 20.

The route calculation device 20 is a server or an equivalent electronic data processing system, for example.

According to the invention, the wireless communication means 14 of the guidance station 10 and of the route calculation device 20 offer low electrical power consumption.

In the preferred embodiment described here, these wireless communication means are provided by the AT86RF210 component from ATMEL.

That component has a standby mode in which it consumes 1 μA at 3 V and an operational mode in which it consumes 15 mA at 3 V when sending and when receiving.

This component conforms to the Zigbee protocol, based on the IEEE 802.15.4 transmission standard published on the Internet at the address: http://standards.ieee.org/wireless/overview.html#802.15.

For more information on the Zigbee protocol, the person skilled in the art may refer to the reference documents of the Zigbee standard, version V0.92, available from the Zigbee Alliance, on the Internet site http://www.zigbee.org.

Be this as it may, the communication means 14 of the guidance station 10 are adapted to send a request to the route calculation device 20 including the code associated with a destination received from the electronic tag 5 and the position indication of the station 10 stored by that station.

In the FIG. 1 embodiment, the three interaction terminals 10 of the guidance system are within range of the route calculation device 20, thereby defining a star network topology.

In the preferred embodiment described here, the route calculation device 20 includes a mediation module 30 that incorporates the low consumption wireless communication means 14 cited above and a central system 40 incorporating calculation means adapted to determine a route between two given addresses within the building.

The central system 40 consists of a server or an equivalent electronic data processing system, for example.

In the preferred embodiment described here, to determine that route, the calculation means 26 cooperate with a cartographic database 21.

In the preferred embodiment described here, the mediation means 30 and the central system 40 of the route calculation device 20 are connected to each other by a local area network 35.

In another embodiment that is not described here, these two entities 30, 40 may equally be connected via a public wide area network (WAN) 35.

Be this as it may, the network link 35 is used by the communication means 14 of the processing module to send the request received from the guidance station 10 to the calculation means 26.

On receipt of that request, the calculation means 26 extract the position of the station 10 and the destination to which the person should go to determine a route within the building.

The calculation means 26 are thereafter adapted to send to the guidance station 10 a response including the route previously obtained using the wireless communication means 14.

According to the invention, the guidance station also includes means 16 for delivering the route to the person, which means 16 may be a little distance away but are preferably in the vicinity of the body of the station itself.

The means 16 for delivering the route to the person may consist of a screen of the interaction module 10, for example, or voice synthesis means adapted to speak the route.

In the embodiment described here, a MGLS 24064G-LED03 LCD display from Varitronix is used.

In the preferred embodiment described here, assuming that a guidance station is interrogated 30 times a minute on average, 10 hours a day, the guidance station consumes from 1.5 to 2 Watts per hour, lumping all operations together.

The guidance station may therefore be powered for several days by a 6 V 10 ampere-hour (Ah) battery.

In a preferred embodiment, the guidance system also includes means 50 for formatting the route as a function of the capacities of the delivering means 16 or of the person for whom the route is intended. For example, voice synthesis is the preferred option to facilitate guiding visually-impaired persons.

In the embodiment represented in FIG. 1, these formatting means 50 are incorporated into the central system 40.

This embodiment is in no way limiting on the invention, and the formatting means 50 may be incorporated in the mediation means 30 or in the guidance station 10.

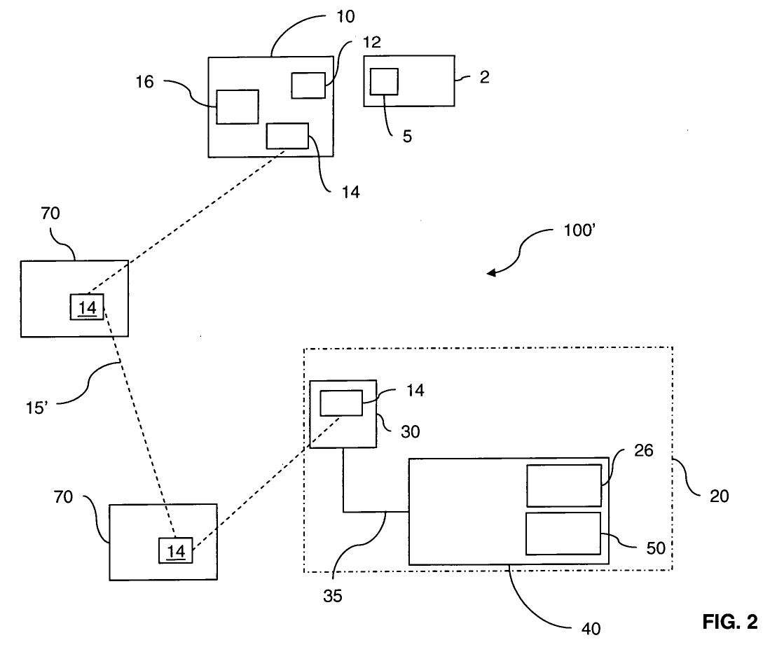

A second embodiment of a guidance system 100′ of the invention is described next with reference to FIG. 2.

This guidance system 100′ uses relays 70 to relay the request and the response between the interaction guidance station 10 and the processing module 20 if those two equipments are out of range of each other, typically more than 30 meters apart.

In this embodiment, the network 15′ consisting of the fixed station 10, the various relays 70, and the route calculation device 20 is a daisychain network. In a variant that is not represented here, these equipments may be arranged to constitute a meshed network.

The relays 70 include communication means 14 similar to those of the station 10 of the calculation device 20.

In a different embodiment, the transmission modules 70 are also guidance stations 10.

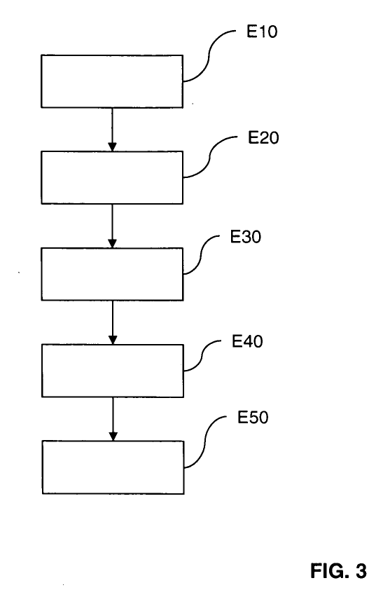

FIG. 3 is a flowchart representing the main steps of a preferred embodiment of a guidance method of the invention.

This guidance method includes a first step E10 of the guidance station 10 reading a code associated with a destination.

As described above, this reading step may be effected by RFID reading means 12 of an electronic tag 5 incorporated into a badge 2 of the person.

The reading step E10 is followed by a first step E20 of the station 10 sending a request including the code associated with a destination and an indication of the position of the terminal 10 to the route calculation device 20.

This first transmission step E20 is followed by a step E30 in which the route calculation device 20 calculates a route between the position of the station 10 and the destination read from the electronic tag 5.

This calculation step E30 is followed a second transmission step during which the route calculation device 20 communicates the route to the station 10 in response to the request cited above.

This second transmission step E40 is followed by a step E50 during which the station 10 delivers the route to the person.

According to the invention, the first transmission step E20 and the second transmission step E40 utilize low electrical power consumption wireless communication means adapted where appropriate to send the request and the response progressively via a relay network 70 including similar communication means.

The invention finds one particular application in the field of logistics. In that application, electronic labels on merchandise, for example gas cylinders, contain information as to where that merchandise must be stored.

Thus a handling operative can bring the electronic tag close to a fixed station at the entrance of a depot, the fixed station being adapted to supply the operative with a route to the appropriate storage area for that type of merchandise.

The destination information stored in the electronic label may include an indication of the type of merchandise to be stored (nature of the gas (inflammable or not)), from which information the route determination device will be able to determine a destination, for example by reading a table storing the codes in association with a storage place.

Thanks to the invention, the route proposed by the guidance station may be a route enabling the handling operative to avoid passing through areas that are hazardous by virtue of the type of merchandise.

1. A fixed station (10) for guiding a person in a predetermined area, the station comprising a memory for storing an indication of the position of said fixed station (10), and:
means (12) for reading a code associated with a destination (Dest) to which a person situated in the vicinity of said station wishes to go;
wireless communication means (14) for:
sending a request including said code associated with a destination (Dest) and said indication (ID10, Pos10) of the position of said fixed station to a route determination device (20); and
receiving a response including a route between said station (10) and the destination associated with said code (Dest); and
means (16) for delivering said route to the person.

2. A fixed station (10) according to claim 1, characterized in that said wireless communication means (14) have a standby mode and a low electrical power consumption operational mode.

3. A fixed station (10) according to claim 1, characterized in that said reading means (12) comprise an RFID module adapted to communicate with an electronic tag (5) for storing said code associated with a destination (Dest).

4. A device for determining a route (20) for a person in a predetermined area, the device comprising:
means (26) for determining a route between two positions (Pos10, Dest) in said predetermined area; and
wireless communication means (14) adapted:
to receive a request including a code associated with a destination (Dest) and a stored position indication (ID10, Pos10) sent by a fixed guidance station (10) according to claim 1; and
to send said fixed station (10) a response including a route between said station (10) and the destination associated with said code (Dest).

5. A route determination device (20) according to claim 4, characterized in that said wireless communication means (14) are low electrical power consumption means.

6. A route determination device (20) according to claim 4, characterized in that it includes means (50) for formatting said response as a function of the capacities of said delivering means (16) and/or said person.

7. A determination device according to claim 4, characterized in that it includes:
a mediation module (30) incorporating said communication means (14); and
a central system (40) incorporating said determination means (26), the central system (40) and the mediation module (30) being connected to each other via a local area network (35), said optional formatting means (50) being adapted in particular to be incorporated into the mediation module (30) or into the central system (40).

8. A system for guiding a person in a predetermined area, characterized in that it comprises:
a fixed guidance station according to claim 1; and
a route determination device comprising:
means (26) for determining a route between two positions (Pos10, Dest) in said predetermined area; and
wireless communication means (14) adapted:
to receive a request including a code associated with a destination (Dest) and a stored position indication (ID10, Pos10) sent by said fixed guidance station (10); and
to send said fixed station (10) a response including a route between said station (10) and the destination associated with said code (Dest).

9. A guidance system according to claim 8, characterized in that it further comprises a relay (70) comprising low electrical power consumption wireless communication means (14), said relay(s) being adapted to send said request and said response step by step between said guidance station (10) and the route determination device (20).

10. A guidance system according to claim 8, characterized in that said relay(s) (70) constitute a daisychain network (15′).

11. A guidance system according to claim 9, characterized in that at least one relay said guidance station.

12. A method of guiding a person in a predetermined area, the method comprising:
a step (E10) of a guidance station (10) according to claim 1 reading a code associated with a destination (Dest) to which said person wishes to go;
a step (E20) of said guidance station (10) sending a request including said code associated with a destination (Dest) and a position indication (Pos10, ID10) stored by said station (10) to a route determination device (20);
a step (E30) of said determination device (20) determining a route between said position (Pos10) and the destination associated with said code (Dest);
a step (E40) of said determination device (20) sending to said station (10) a response including said route; and
a step (E50) of delivering the route to the person wherein said route determination device comprises:
means (26) for determining a route between two positions (Pos10, Dest) in said predetermined area; and
wireless communication means (14) adapted:
to receive a request including a code associated with a destination (Dest) and a stored position indication (ID10, Pos10) sent by said fixed guidance station (10); and
to send said fixed station (10) a response including a route between said station (10) and the destination associated with said code (Dest).

13. A computer program on an information medium, said program being adapted to be executed in a fixed guidance station (10) according to claim 1 and comprising instructions adapted to execute the following steps:
reading (E10) a code associated with a destination (Dest);
sending (E20) a route determination device (20) a request including said code associated with a destination (Dest) and a position indication (ID10, Pos10) stored by said station (10);
receiving from said determination device (20) a response including a route between said station (10) and the destination associated with said code (Dest); and
delivering (E50) the route to the person.

14. An information medium readable by a fixed guidance station (10) according to claim 1, characterized in that it contains instructions of a computer program adapted to execute the following steps:
reading (E10) a code associated with a destination (Dest);
sending (E20) a route determination device (20) a request including said code associated with a destination (Dest) and a position indication (ID10, Pos10) stored by said station (10);
receiving from said determination device (20) a response including a route between said station (10) and the destination associated with said code (Dest); and
delivering (E50) the route to the person.
